(19) United States
(12) Patent Application Publication
(10) Pub. No.: US 2021/0264322 A1
(43) Pub. Date: Aug. 26, 2021

(54) COMPUTER-IMPLEMENTED SYSTEMS, METHODS AND COMPUTER PROGRAMS FOR ADAPTING A MACHINE-LEARNING-ARCHITECTURE AND FOR PROCESSING INPUT DATA

(71) Applicant: Sony Semiconductor Solutions Corporation, Kanagawa (JP)

(72) Inventors: Lev MARKHASIN, Basingstoke (GB); Shangyin GAO, Basingstoke (GB)

(73) Assignee: Sony Semiconductor Solutions Corporation, Kanagawa (JP)

(21) Appl. No.: 17/179,451

(22) Filed: Feb. 19, 2021

(30) Foreign Application Priority Data
Feb. 26, 2020 (EP) 20159629.3

(51) Int. Cl. G06N 20/20; G06K 9/62

(52) U.S. Cl. CPC G06N 20/20; G06K 9/6262; G06K 9/6228; G06K 9/6288

(57) ABSTRACT

Examples relate to a computer-implemented system, a computer-implemented method and a computer program for adapting a machine-learning-architecture, and to a computer-implemented system, a computer-implemented method and a computer program and for processing input data using a machine-learning model having a machine-learning architecture. The computer-implemented system for adapting a machine-learning architecture of a first machine-learning model comprises one or more processors and one or more storage devices. The machine-learning architecture comprises a color image branch configured to process color image data. The color image branch comprises a sequence of convolution blocks. The machine-learning architecture comprises a depth branch configured to process depth data. The depth branch comprises a sequence of convolution blocks. The machine-learning architecture comprises one or more fusing components configured to combine intermediary data of two or more of the branches. Each fusing component is configured to combine an output of a first block of one of the branches and an output of a second block of another branch. An output of the fusing component is used as input of a third block of one of the branches. The third block is a convolution block of one of the sequences of convolution blocks. The machine-learning architecture comprises an output component configured to provide an output of the machine-learning model. The output is based on an output of one or more of the branches. The system is configured to adapt the machine-learning architecture of the first machine-learning model using a second machine-learning model. The second machine-learning model is trained to select, for each of the one or more fusing components, the first block, the second block, and the third block.

### CROSS-REFERENCE TO RELATED APPLICATION

The present application claims priority to European Patent Application No. 20159629.3 filed by the European Patent Office on Feb. 26, 2020, the entire contents of which being incorporated herein by reference.

### FIELD

Examples relate to a computer-implemented system, a computer-implemented method and a computer program for adapting a machine-learning-architecture, and to a computer-implemented system, a computer-implemented method and a computer program for processing input data using a machine-learning model having a machine-learning architecture.

### BACKGROUND

Sensor fusion for RGB (Red-Green-Blue, a color image representation) and depth (D) images is becoming more and more important. For example, object detection is often performed on fused (i.e. combined) RGB-D data. In object detection, the use of both RGB and depth data shows significant improvement over the use of RGB only or depth only data. For example, if the performance of RGB-only object detection and of depth-only object detection is evaluated using the publicly available SUN-RGBD data set (S. Song, S. Lichtenberg, and J. Xiao. SUN RGB-D: A RGB-D Scene Understanding Benchmark Suite. Proceedings of 28th IEEE Conference on Computer Vision and Pattern Recognition data set), the RGB-only approach yielded a mAP (mean Average Precision in %) score of 52.5, and a depth-only approach yielded a mAP score of 50.4.

If the RGB and depth data is used together, higher scores may be obtained. For example, there are several ways of fusing the RGB images with the depth images. For example, signal-level RGB-D fusion may be used, which is an approach wherein depth data is simply considered as an additional channel of the input data alongside RGB channels such that the input data has 4 channels. When this approach is taken, an evaluation that was performed based on the ScratchDet detection network yielded a mAP score of 57.4. Alternatively, the RGB and D may be fused on the score level, which means that two parallel branches of detection networks are used for the RGB and depth data, and two outputs are received. An average of these outputs may be used as fusion result. This score-level RGB-D fusion yielded a mAP score of 57.0 in an evaluation.

Finally, there is the option of fusing between the network in any feature map. This approach has been considered by FuseNet (Hazirbas, Caner, et al. “Fusenet: Incorporating depth into semantic segmentation via fusion-based cnn architecture.” Asian conference on computer vision. Springer, Cham, 2016.), and its detection result is a mAP of 57.9.

### SUMMARY

There is a desire for providing an improved concept for object detection using RGB and depth data.

This desire is addressed by the subject-matter of the independent claims.

Embodiments may address the desire of improving the fusion of RGB and D data channels. Embodiments of the present disclosure are based on the finding, that the performance of machine-learning models for processing RGB and depth data can be further improved by improving the fusion of the RGB and depth data using one or several measures. For example, the fusion of the RGB and depth data may be improved using a second machine-learning model (denoted “controller” machine-learning model) that is trained to adapt the machine-learning architecture of the (first) machine-learning model being used to process the RGB and depth data. For example, the controller machine-learning model may iteratively adapt the first machine-learning model by determining a performance estimate of the machine-learning model using a set of training data, adapting the machine-learning architecture, re-determining the performance estimate and repeating the process until a termination condition is met. Additionally, different base architectures may be used to improve the performance. For example, the machine-learning architectures of at least some embodiments may use a combined (or mixed) branch that the RGB and depth data is fused into, and which is maintained in parallel to the RGB and depth branches. To further improve the performance, the fusion into the combined branch may be controlled by an attention mechanism that is based both on the RGB data and on the depth data. Embodiments may thus provide an improved concept for machine-learning for use with an image sensor.

At least some embodiments of the present disclosure provide a computer-implemented system for adapting a machine-learning architecture of a first machine-learning model. The system comprises one or more processors and one or more storage devices. The machine-learning architecture comprises a color image branch configured to process color image data. The color image branch comprises a sequence of convolution blocks. The machine-learning architecture comprises a depth branch configured to process depth data. The depth branch comprises a sequence of convolution blocks. The machine-learning architecture comprises one or more fusing components configured to combine intermediary data of two or more of the branches. Each fusing component is configured to combine an output of a first block of one of the branches and an output of a second block of another branch. An output of the fusing component is used as input of a third block of one of the branches. The third block is a convolution block of one of the sequences of convolution blocks. The machine-learning architecture comprises an output component configured to provide an output of the machine-learning model. The output is based on an output of one or more of the branches. The system is configured to adapt the machine-learning architecture of the first machine-learning model using a second machine-learning model. The second machine-learning model is trained to select, for each of the one or more fusing components, the first block, the second block, and the third block. By adapting the architecture of the machine-learning model, which may be performed in addition to the training of the machine-learning model, the overall performance of the first machine-learning model may be improved.

In some embodiments, the second machine-learning model is further trained to select, for each of the one or more fusing components, a combination operator being used by the fusing component. For example, different combination operators may yield different performance results, so an adaptation of the combination operator may further improve the performance of the first machine-learning model.

For example, the second machine-learning model may be further trained to select a number of fusing components to use in the machine-learning architecture. Also the number of fusing components being used may affect the performance of the first machine-learning model.

In various embodiments, the machine-learning architecture comprises a combined branch configured to process combined color image and depth data. The combined branch may comprise a sequence of convolution blocks. An input to the combined branch may be provided by one of the fusing components. The use of a combined branch in addition to the depth and color image branches may further improve the performance of the first machine-learning model.

For example, the one fusing component may be configured to generate the combined color image and depth data based on an output of a convolution block of the color image branch and based on an output of a convolution block of the depth branch. The one fusing component may be configured to generate the combined color image and depth data using an attention mechanism that is based on the output of the convolution block of the color image branch and based on the output of the convolution block of the depth branch. Such an attention mechanism may further increase the performance of the first machine-learning model.

In some embodiments, the one or more fusing components comprise a subset of fusing components being configured to combine an output of a first block of one of the branches, an output of a second block of another branch, and an output of a fourth block of a further branch. An output of the fusing component may be used as input of a third block of one of the branches. The machine-learning model may be further trained to select, for each fusing component of the subset, the fourth block. If three branches are being fused, the second machine-learning model may be further used to determine the fourth block (of the third branch).

In various embodiments, the second machine-learning model is further trained to select a number of convolution blocks of the sequences of convolution blocks. The number of convolution blocks may further affect the performance of the first machine-learning model.

In various embodiments, the system is configured to iteratively adapt the machine-learning architecture by determining a performance estimate of the first machine-learning model being based on the machine-learning architecture, providing the performance estimate as input to the second machine-learning model, using an output of the second machine-learning model to adapt the machine-learning architecture, determining a performance estimate of the machine-learning model being based on the adapted machine-learning architecture, and repeating the process until a termination condition is met. Thus, the performance of the first machine-learning may be iteratively improved by iteratively adapting the machine-learning architecture of the first machine-learning model.

For example, the performance estimate of the machine-learning model may be determined using a set of training data. The set of training data may comprise color image data, depth data, and desired output data. The system may be configured to trigger the adaption of the machine-learning architecture if the set of training data is changed. The system may be configured to generate the first machine-learning model based on the adapted machine-learning architecture after the adaption of the machine-learning architecture. The system may be configured to train the first machine-learning model based on the set of training data. Thus, the machine-learning architecture may be adapted when new training data is available, and the first machine-learning model may be re-created accordingly.

In various embodiments, the system is configured to process input data comprising color image data and depth data using the first machine-learning model. Thus, the system may be suitable for processing color image data and depth data.

Various embodiments of the present disclosure further provide a computer-implemented system for processing color image data and depth data. The system comprises one or more processors and one or more storage devices. The system is configured to process the color image data and the depth image data using a machine-learning model having a machine-learning architecture. The machine-learning architecture comprises a color image branch configured to process the color image data. The color image branch comprises a sequence of convolution blocks. The machine-learning architecture comprises a depth branch configured to process the depth data. The depth branch comprises a sequence of convolution blocks. The machine-learning architecture comprises a combined branch configured to process combined color image and depth data. The combined branch comprises a sequence of convolution blocks. The machine-learning architecture comprises one or more fusing components configured to generate the combined color image and depth data based on an output of a convolution block of the color image branch and based on an output of a convolution block of the depth branch.

The one or more fusing components are each configured to generate the combined color image and depth data using an attention mechanism that is based on the output of the convolution block of the color image branch and based on the output of the convolution block of the depth branch. The machine-learning architecture comprises an output component configured to provide an output of the machine-learning model. The output is based at least on an output of the combined branch. Such an attention mechanism may increase the performance of the machine-learning model.

For example, the output component may be configured to provide the output further based on an output of the color image branch and/or based on an output of the depth branch. Such score-level fusion may further increase the performance of the machine-learning model.

The output component may be configured to perform a combination operation based on the output of the combined branch and based on the output of at least one of the color image branch and the depth branch. For example, the combination operation may be an averaging operation. Such a combination operation/averaging operation may provide the score-level fusion of the branches.

For example, at least the combined branch may comprise one or more detection head layers and a prediction layer. The prediction layer may be configured to provide an output of the respective branch based on an output of the one or more detection head layers. The one or more detection head layers may be configured to process an output of the one or more convolution blocks of the respective branch. The previously introduced sequences of convolution blocks may be trained for an initial processing of the color image data, depth data and combined data, while the detection head layers and the prediction layers may be trained to perform the actual functionality of the machine-learning model, e.g. object detection.

Embodiments of the present disclosure further provide corresponding methods. At least some embodiments of the present disclosure provide a computer-implemented method for adapting a machine-learning architecture of a first machine-learning model. The machine-learning architecture comprises a color image branch configured to process color image data. The color image branch comprises a sequence of convolution blocks. The machine-learning architecture comprises a depth branch configured to process depth data. The depth branch comprises a sequence of convolution blocks. The machine-learning architecture comprises one or more fusing components configured to combine intermediary data of two or more of the branches. Each fusing component is configured to combine an output of a first block of one of the branches and an output of a second block of another branch. An output of the fusing component is used as input of a third block of one of the branches. The third block is a convolution block of one of the sequences of convolution blocks. The machine-learning architecture comprises an output component configured to provide an output of the machine-learning model. The output is based on an output of one or more of the branches. The method comprises adapting the machine-learning architecture of the first machine-learning model using a second machine-learning model. The second machine-learning model is trained to select, for each of the one or more fusing components, the first block, the second block, and the third block.

At least some embodiments of the present disclosure provide a computer-implemented method for processing color image data and depth data. The method comprises processing the color image data and the depth image data using a machine-learning model having a machine-learning architecture. The machine-learning architecture comprises a color image branch configured to process the color image data. The color image branch comprises a sequence of convolution blocks. The machine-learning architecture comprises a depth branch configured to process the depth data. The depth branch comprises a sequence of convolution blocks. The machine-learning architecture comprises a combined branch configured to process combined color image and depth data. The combined branch comprises a sequence of convolution blocks. The machine-learning architecture comprises one or more fusing components configured to generate the combined color image and depth data based on an output of a convolution block of the color image branch and based on an output of a convolution block of the depth branch. The one or more fusing components are each configured to generate the combined color image and depth data using an attention mechanism that is based on the output of the convolution block of the color image branch and based on the output of the convolution block of the depth branch. The machine-learning architecture comprises an output component configured to provide an output of the machine-learning model. The output is based at least on an output of the combined branch.

At least some embodiments of the present disclosure provide a computer program having a program code for performing at least one of the above methods, when the computer program is executed on a computer, a processor, or a programmable hardware component.

### BRIEF DESCRIPTION OF THE FIGURES

Some examples of apparatuses and/or methods will be described in the following by way of example only, and with reference to the accompanying figures, in which

FIG. 1a shows a block diagram of an embodiment of a system for adapting a machine-learning architecture, or of an embodiment of a system for processing input data;

FIG. 1b shows a flow chart of an embodiment of a method for adapting a machine-learning architecture;

FIG. 1c shows a flow chart of an embodiment of a method for processing input data;

FIGS. 2a to 2d show illustrations of an object detection being evaluated;

FIG. 3 shows a schematic diagram of an approach for adapting a machine-learning architecture;

FIG. 4 shows a schematic diagram of different hidden layers being used for adapting a machine-learning architecture;

FIG. 5 shows a schematic diagram of a machine-learning architecture of a machine-learning model for processing input data;

FIG. 6 shows a schematic diagram of another machine-learning architecture of a machine-learning model for processing input data;

FIG. 7 shows a schematic diagram of different layers being used for adapting a machine-learning architecture;

FIG. 8 shows a schematic diagram of a machine-learning architecture of a machine-learning model for processing input data, the machine-learning architecture comprising a combined/mixed branch;

FIG. 9 shows a schematic diagram of a machine-learning architecture of a machine-learning model for processing input data, the machine-learning architecture comprising a combined/mixed branch and a fusing component that uses an attention mechanism; and

FIG. 10 shows a schematic diagram of an attention mechanism for a machine-learning architecture.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

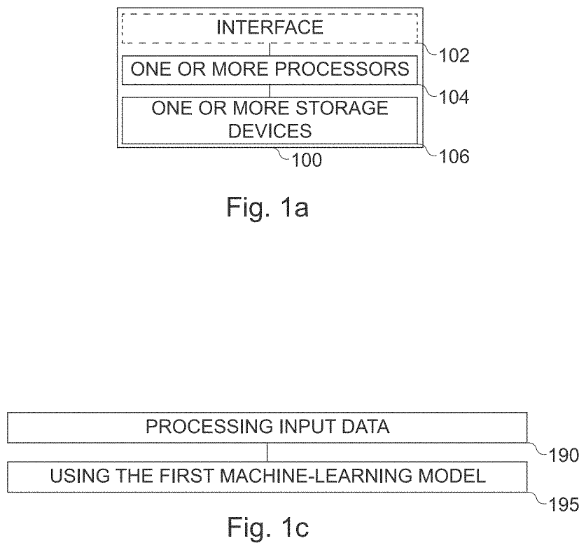

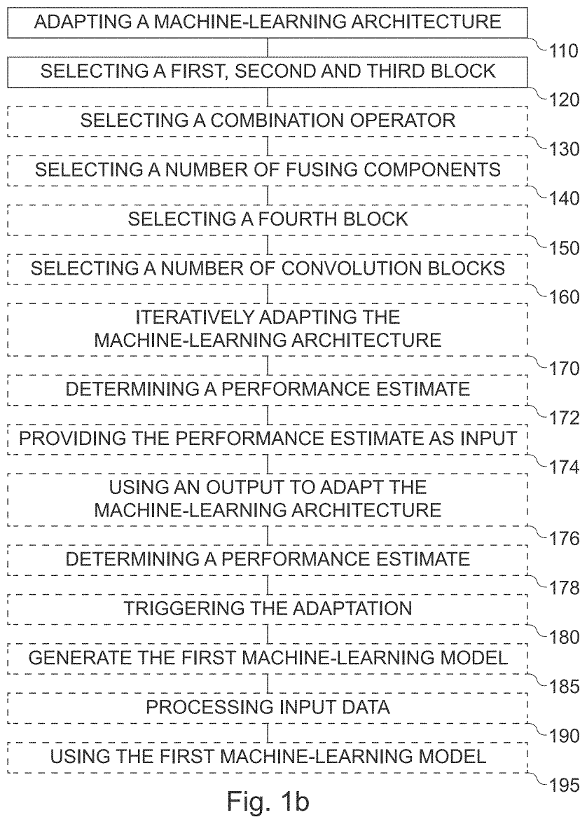

FIG. 1a shows a block diagram of an embodiment of a (computer-implemented) system 100 for adapting a machine-learning architecture of a first machine-learning model. The system 100 comprises one or more processors 104 and one or more storage devices 106. Optionally, the system comprises an interface 102. The one or more processors 104 are coupled to the one or more storage devices 106 and to the interface 102. In general, the one or more processors may provide the functionality of the system 100, e.g. in conjunction with the interface and/or the one or more storage devices. For example, the one or more storage devices may be configured to store the first and/or a second machine-learning model, and/or to store a set of training data. The interface may be configured to obtain (i.e. receive) and/or provide (i.e. transmit) information.

The machine-learning architecture comprises a color image branch configured to process color image data. The color image branch comprises a sequence of convolution blocks. The machine-learning architecture comprises a depth branch configured to process depth data. The depth branch comprises a sequence of convolution blocks. The machine-learning architecture comprises one or more fusing components configured to combine intermediary data of two or more of the branches. Each fusing component is configured to combine an output of a first block of one of the branches and an output of a second block of another branch. An output of the fusing component is used as input of a third block of one of the branches. The third block may be a convolution block of one of the sequences of convolution blocks. The machine-learning architecture comprises an output component, configured to provide an output of the machine-learning model. The output is based on based on an output of one or more of the branches.

The system is configured to adapt 110 the machine-learning architecture of the first machine-learning model using a second machine-learning model. The second machine-learning model is trained to select 120, for each of the one or more fusing components, the first block, the second block, and the third block.

FIG. 1b shows a flow chart of an embodiment of a corresponding method for adapting the machine-learning architecture of the first machine-learning model. The method comprises adapting 110 the machine-learning architecture of the first machine-learning model using the second machine-learning model.

The following description relates both to the system of FIG. 1a and to the method of FIG. 1b. Features described in connection with the system of FIG. 1a may be likewise applied to the method of FIG. 1b.

Various embodiments of the present disclosure relate to a system, method and computer-program for adapting a machine-learning architecture of a first machine-learning model. Machine learning refers to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and associated training content information, the machine-learning model “learns” to recognize the content of the images, so the content of images that are not included of the training images can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model.

In general, a machine-learning model, such as the first machine-learning model, is based on a machine-learning architecture, which may define the inner workings of the machine-learning model. In general, a machine-learning model may comprise a plurality of interconnected layers, with the plurality of interconnected layers comprising one or more input layers for inputting input data, one or more output layers for outputting output data, and one or more hidden layers for performing a transformation between the input data and the output data. In general, the layers and the interconnections between the layers are defined by the machine-learning architecture of the machine-learning model. In other words, the machine-learning architecture of the first machine-learning model may define the layers of the first machine-learning model, and how the layers of the first machine-learning model are interconnected. The machine-learning architecture of the first machine-learning model may thus define the inner structure of the first machine-learning model.

In general, the first machine-learning model is suitable for processing input data comprising color image data and depth data. Accordingly, the system might not only be configured to adapt the machine-learning architecture of the first machine-learning model, but also to use the first machine-learning model to process such input data. In other words, the system may be configured to process 190 input data comprising color image data and depth data using 195 the first machine-learning model. For example, the system may be configured to process 190 the image data and perform one of object detection, image classification, image segmentation, post estimation, secure authentication (or other related image processing tasks) using 195 the first machine-learning model. In general, the color image data and the depth data of the input data may show the same subject, at (approximately) the same time. For example, the color image data and depth data may show a corresponding field of view, e.g. an identical or overlapping field of view. It may be one objective of the first machine-learning model to “fuse” (i.e. combine) the color image data with the depth data. In this context, the term “color image data” may be data provided by an optical two-dimensional camera sensor, and the depth data may be data provided by a depth sensor, such as a Time-of-Flight sensor or by a stereoscopic depth sensor. In the following, the term “RGB data” may be used interchangeably with the term “color image data”, although embodiments are not limited to color image data provided in an RGB representation. Other representations may be supported as well.

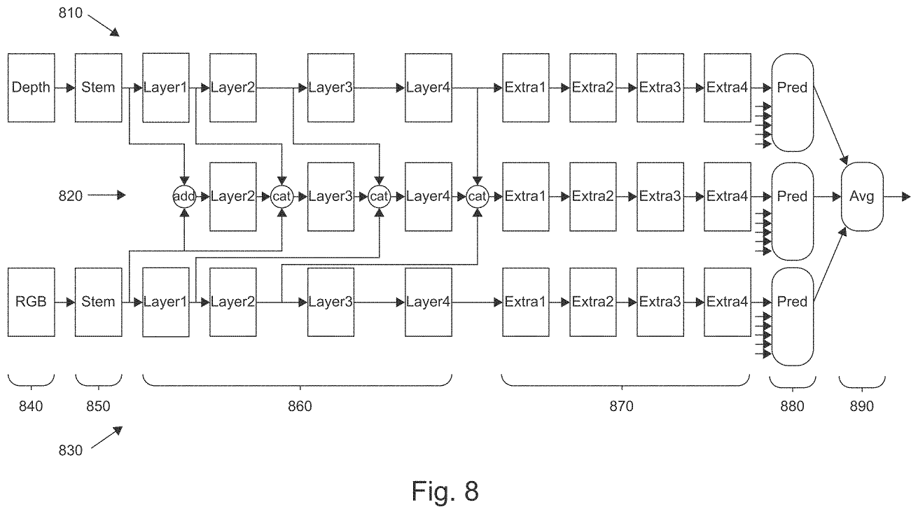

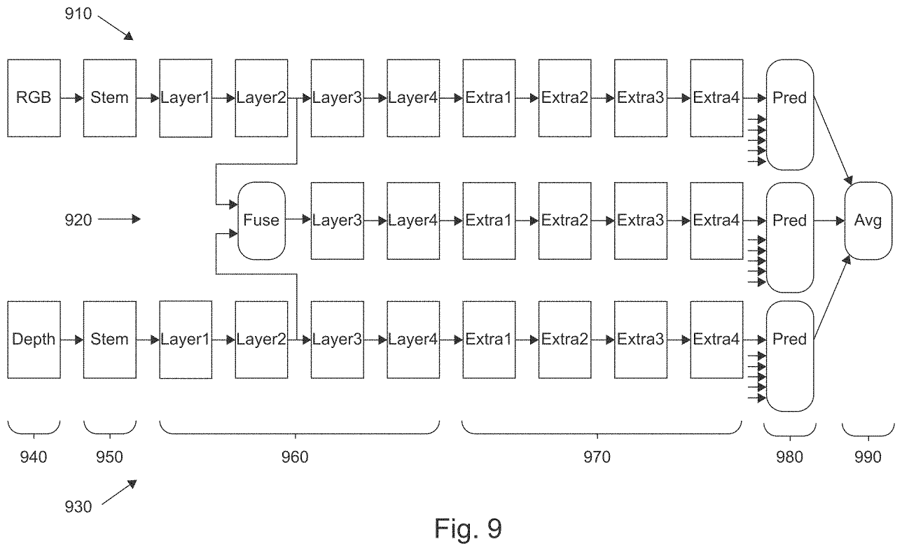

As has been introduced before, the machine-learning architecture comprises a color image branch configured to process the color image data, and a depth branch configured to process depth data. The term “branch” denotes a sequence of layers that are configured to sequentially process the same input data (or processed versions thereof). For example, the color image branch comprises a plurality of layers that is configured to process data that is at least derived from the color image data. Accordingly, the depth branch comprises a plurality of layers that is configured to process data that is at least derived from the depth data. In some embodiments, the machine-learning architecture further comprises a combined branch configured to process combined color image and depth data. An input to the combined branch may be provided by one of the fusing components. The combined branch comprises a plurality of layers that is configured to process data that is at least derived from the depth data and from the color image data. Examples of color image branches can be found in FIGS. 5, 6, 8 and 9 (510; 605; 830; 910), examples of depth branches can also be found in FIGS. 5, 6, 8 and 9 (520; 600; 810; 930), and examples of combined branches can be found in FIGS. 8 and 9 (820; 920). In the following, the combined branch may also be denoted “mixed” branch. In the combined branch, the depth data and the color image data is fused.

Each of the branches comprises a sequence of convolution blocks (see e.g. FIGS. 5, 6, 8 and 9, 540; 570; 630; 860; 960). In color image data and depth data processing, convolution blocks are used to perform initial processing of the color image data and depth data. In general, each convolution block may comprise multiple layers, such as one or more convolution layers and a Rectified Linear Unit (ReLU). Optionally, further layers may be included, such as a batch normalization layer. Each convolution layer may be configured to reduce a spatial resolution of the data that is input to the convolution layer, while retaining the relevant features of the data that is input to the convolution layer. A ReLU is a layer that is configured to trigger the release of neurons based on an activation function. In general, the convolution layers of a convolution blocks are used as inputs to the activation function of the ReLU, and trigger the release of neurons that are provided to other layers/blocks. Each of the branches comprises a sequence of such convolution blocks, e.g. a plurality of such convolution blocks that are included in sequential order within the machine-learning architecture. The convolution blocks are used to perform pre-processing of the color image data and of the depth data.

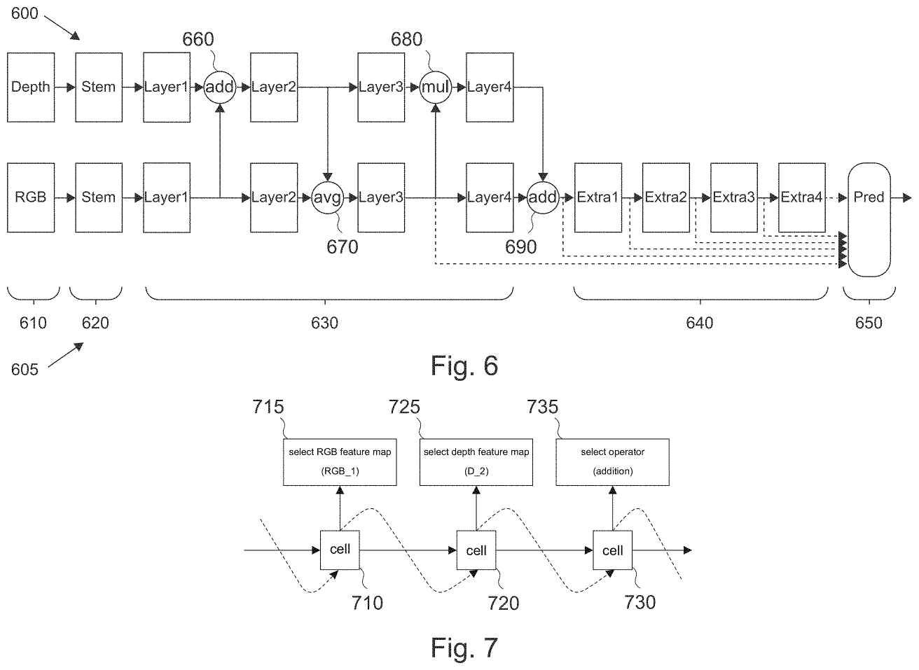

Each or some of the branches may comprise additional layers or blocks, such as input layers/blocks (FIG. 5 530, FIG. 6 610, FIG. 8 840, FIG. 9 940) and stem layers (FIG. 6 620, FIG. 8 850, FIG. 9 950). Additionally, at least one of the branches may comprise one or more detection head layers (FIG. 8 870, FIG. 9 970) and a prediction layer (FIG. 8 880, FIG. 9 980). For example, the color image branch, the depth branch and/or the combined branch may comprise one or more detection head layers and a prediction layer, as shown in FIGS. 8 and 9. The prediction layer may be configured to provide an output of the respective branch based on an output of the one or more detection head layers. The one or more detection head layers may be configured to process an output of the one or more convolution blocks of the respective branch. These blocks/layers are configured to perform the actual functionality of the machine-learning model that is based on the machine-learning architecture, such as object detection.

The machine-learning architecture further comprises the output component, which is configured to provide the output of the machine-learning model, based on an output of one or more of the branches. For example, only one of the branches (e.g. the combined branch) may be coupled to the output component. In this case, the output component may be configured to provide the output of the respective branch as output of the machine-learning model. Alternatively, the output of two or more of the branches may be combined by the output component. For example, the output component may be configured to perform a combination operation based on an output of two or more of the branches, e.g. based on an output of the depth branch and of the color image branch, or based on an output of the combined branch and at least one of the depth branch and the color image branch. For example, the combination operation (which may also be denoted a fusing operation) may be one of several operations, e.g. an (elementwise) averaging operation, a concatenation operation (in channel dimension), an (elementwise) maximization operation, an (elementwise) addition operation or an (elementwise) multiplication operation.

Additionally, the machine-learning architecture comprises the one or more fusing components configured to combine intermediary data of two or more of the branches. Such fusing components are also shown in FIGS. 5 (530; 580), 6 (660; 670; 680; 690) and also in FIGS. 8 and 9 (as part of the combined branch 820/920). In general, the fusing components are used to fuse (i.e. combine) data of two or more branches together (using a combination operation), which is subsequently input to a subsequent block of one of the branches. Again, the combination operation may be one of several operations, e.g. an (elementwise) averaging operation, a concatenation operation (in channel dimension), an (elementwise) maximization operation, an (elementwise) addition operation or an (elementwise) multiplication operation. Accordingly, each fusing component is configured to combine an output of a first block of one of the branches (e.g. of the color image branch) and an output of a second block of another branch (e.g. of the depth branch). In some embodiments, three branches are used (color image, depth and combined), therefore, one or more of the fusing components may be configured to combine data of the three branches. In other words, the one or more fusing components may comprise a subset of fusing components being configured to combine an output of a first block of one of the branches (e.g. of the color image branch), an output of a second block of another branch (e.g. of the depth branch), and an output of a fourth block of a further branch (e.g. of the combined branch). The output of the fusing component may be used as input of a subsequent block of one of the branches. In other words, the output of the fusing component is used as input of a third block of one of the branches. For example, the third block may be a convolution block of one of the sequences of convolution blocks. Alternatively, the third block may be another block, e.g. a detection head block of one of the branches. In general, the output of one fusing component is used as input to the combined branch (there being no input layer for the combined branch).

In general, when the output of different branches is being fused, this may require that the data being fused has (at least) the same spatial resolution. When branches having different spatial resolutions are being fused, down-sampling may be performed, e.g. using another convolution layer.

In general, the placement of the one or more fusing components, and therefore the input and output connections of the one or more fusing components determine the performance of the machine-learning model being based on the machine-learning architecture. Therefore, the system is at least configured to determine the placement of the one or more fusing components within the machine-learning architecture. This is done using the second machine-learning model.

In general, the second machine-learning model is a machine-learning model that is trained to identify the parameters to be used for adapting the machine-learning architecture, in a way, that increases an estimated performance of a machine-learning model being based on the machine-learning architecture. To achieve this, an iterative approach may be taken. The system may be configured to use the second machine-learning model to iteratively adapt the machine-learning architecture. In other words, the system may be configured to iteratively adapt 170 the machine-learning architecture. In an iterative adaptation, the performance of a current configuration of the machine-learning architecture may be estimated, the performance estimate may be provided to the second machine-learning model (together with the current configuration of the machine-learning architecture). The second machine-learning model may be configured to (i.e. trained to) process the performance estimate with the (together with the current configuration of the machine-learning architecture), and to generate an output that in turn may be used to adapt the machine-learning architecture, for which a performance estimate is determined. This process may be repeated until a termination condition is reached. In other words, the system may be configured to use the second machine-learning model to iteratively adapt the machine-learning architecture by determining 172 a performance estimate of the first machine-learning model being based on the machine-learning architecture, providing 174 the performance estimate as input to the second machine-learning model, using 176 an output of the second machine-learning model to adapt the machine-learning architecture, determining 178 a performance estimate of the machine-learning model being based on the adapted machine-learning architecture, and repeating the process until a termination condition is met. For example, the termination condition may be one of a number of iterations (e.g. 10 iterations or 20 iterations) or a relative improvement in between iterations.

In general, the performance estimate of the first machine-learning model being based on the machine-learning architecture is determined using a set of training data. The set of training data comprises color image data, depth data, and desired output data. The set of training data may be used to train the first machine-learning model, with the first machine-learning model being based on the machine-learning architecture being evaluated. To perform the evaluation, the set of training data may be divided into two subsets—a subset that is used for training the first machine-learning model, and another subset that is used for evaluating the trained machine-learning model. For example, the depth data and color image data of the subset that is used for evaluating the trained machine-learning model may be input into the trained first machine-learning model, and the output of the trained first machine-learning model may be compared to the desired output data of the subset that is used for evaluating the trained machine-learning model in order to estimate the performance of the first machine-learning model being based on the machine-learning architecture being evaluated.

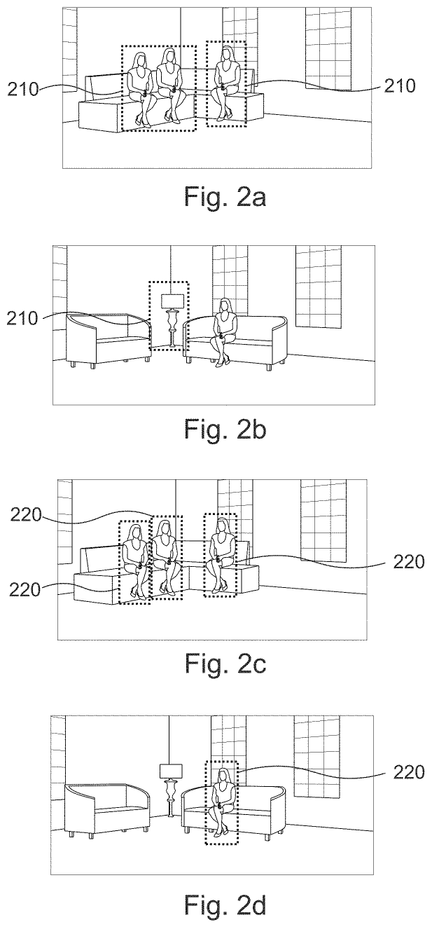

In some embodiments, the set of training data is changed. For example, as introduced in connection with FIGS. 2a to 2d, the first machine-learning model may be used with a consumer electronics device that is being used by a user. The consumer electronics device, implemented by the system 100, may be configured to generate additional or replacement training samples for the set of training data based on an input of the user. For example, the system may be configured to process color image data and depth data using the first machine-learning model, and present a result of the processing to the user. For example, as shown in FIGS. 2a to 2d, the first machine-learning model may be used to perform object detection based on the color image data and depth data, and the result of the object detection may be presented to the user. The user may adjust the result, e.g. using a touch-screen input of the consumer electronics device, or using another device, such as a smartphone, a computer or a tablet computer, and the adjusted result may be added as desired output data to the set of training data, together with the corresponding color image data and the corresponding depth data.

If the set of training data is changed, the adaptation of the machine-learning architecture may be triggered. In other words, the system may be configured to trigger 180 the adaption of the machine-learning architecture if the set of training data is changed (e.g. if a change of the set of training data surpasses a threshold). The system may be configured to (re-) generate 185 the first machine-learning model based on the adapted machine-learning architecture after the adaption of the machine-learning architecture. The system may be configured to train the first machine-learning model based on the set of training data. In some embodiments, the system may be configured to retain the trained first machine-learning model of the last iteration of the iterative adaptation.

As has been introduced above, the system is configured to adapt 110 the machine-learning architecture of the first machine-learning model using the second machine-learning model. The second machine-learning model may be configured to, i.e. trained to, adapt one or more parameters of the machine-learning architecture. For example, the second machine-learning model is trained to select 120, for each of the one or more fusing components, the first block, the second block, and the third block. Optionally, if there are three branches, the second machine-learning model may also be trained to select the fourth block for a subset of the one or more fusing components. In other words, the machine-learning model may be further trained to select 150, for each fusing component of the subset, the fourth block. The first, second, third, and optionally fourth block may determine the location of the respective fusing component within the machine-learning architecture, by defining the inputs of the fusing component, and the block the output block is provided to. The system may be configured to use the first, second, third, and optionally forth block selected by the second machine-learning model to adapt the machine-learning architectures.

In addition to the location of the one or more fusing components, one or several other parameters of the machine-learning architecture may be adapted. For example, the second machine-learning model may be further trained to select 130, for each of the one or more fusing components, a combination operator being used by the fusing component. For example, the combination operator may be one of several operators, e.g. an (elementwise) averaging operator, a concatenation operator (in channel dimension), an (elementwise) maximization operator, an (elementwise) addition operator or an (elementwise) multiplication operator. The system may be configured to adapt the machine-learning architecture based on the combination operator selected for each fusing component.

In some embodiments, the second machine-learning model may be further trained to select 140 a number of fusing components to use in the machine-learning architecture. Correspondingly, the second machine-learning model may be further trained to select 160 a number of convolution blocks of the sequences of convolution blocks. In other words, the machine-learning model may be trained to select not only where within a pre-defined architecture the fusing components are to be used, but also select the number of convolution blocks and the number of fusing components. The system may be configured to adapt the number of convolution blocks of the sequences of convolution blocks and/or the number of fusing components to use for the machine-learning architecture based on the selected number of convolution blocks and/or based on the selected number of fusing components. In general, a search space of the adaptation may be limited, e.g. to a selection of combination operators, to a range for the number of fusing components, to a range for a number of convolution blocks of the sequences of convolution blocks, by a difference in resolution between inputs etc.

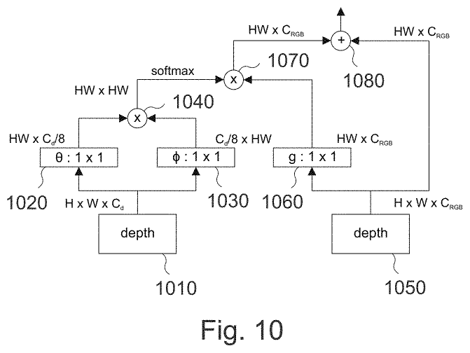

In some embodiments, at least some of the fusing components may be combined with a so-called attention mechanism. In general, an attention mechanism is a mechanism for determining a selective focus on a subset of features provided at an input within a machine-learning model/architecture. For example, the attention mechanism may direct the focus on one or features of the input. This may be done using a set of weights for the features of the input. In consequence, some of the features of the input may be treated with more weight than other features of the input. In the context of the present disclosure, the attention mechanism may be used to fuse the data of the different branches, e.g. to obtain the input of the combined branch. For example, the input to the combined branch may be provided by one of the fusing components. Said fusing component may be configured to generate the combined color image and depth data based on an output of a convolution block of the color image branch and based on an output of a convolution block of the depth branch. Said fusing component may be used to generate the input fur the combined branch. Said fusing component may be configured to generate the combined color image and depth data using an attention mechanism that is based on the output of the convolution block of the color image branch and based on the output of the convolution block of the depth branch. In other approaches, one of the branches may be used as a source of the attention mechanism, and the attention mechanism may be used to provide selective focus on the input provided by the respective other branch. For example, in these systems, the depth data may be used as input to the attention mechanism, and the output of the attention mechanism may be used to provide selective focus on the input provided by the respective other branch. In embodiments, however, the attention mechanism may be based on both the color image branch and the depth branch. For example, the attention mechanism may be based on both the color image branch and the depth branch, and the output of the attention mechanism may be used to provide selective focus on the input provided by the color image branch (or alternatively the depth branch). The attention mechanism may provide sets of weights for both an input provided by the color image branch and for an input provided by the depth branch. The two weighted inputs may be combined using a combination operator, and the output of this combination operation may be combined with an input of one of the branches. The two sets of weights may be trained in the training of the machine-learning model. An example for such an attention mechanism is shown in connection with FIG. 10, where the multiplication operator 1070 provides the output of the attention mechanism (the weighted input of the depth branch 1010 and the weighted input of the RGB branch 1050), which is used to provide selective focus on the input by the RGB branch 1050 via the addition operator 1080. For example, the second machine-learning model may be trained to select, which of the one or more fusing components are to use the attention mechanism. The system may be configured to adapt the machine-learning architecture based on the selection of the one or more fusing components that are to use the attention mechanism.

As has been pointed out before, the above system may be used for processing color image data and depth data. In some embodiments, this feature may be used in isolation from the adaptation of the machine-learning architecture of the first machine-learning model. In other words, not all of the embodiments of the system 100 might be configured to adapt the machine-learning architecture of the first machine-learning model.

In this case, the system may be merely used to process the input data. In other words, the system 100 may be configured to process 190 the color image data and the depth image data using a machine-learning model having a machine-learning architecture. For example, the machine-learning model may be the first machine-learning model, or may be implemented similar to the first machine-learning model as introduced above. Accordingly, the machine-learning architecture of the machine-learning model may be the machine-learning architecture of the first machine-learning model, or may be implemented similar to the machine-learning architecture of the first machine-learning model. The machine-learning architecture comprises a color image branch configured to process the color image data, the color image branch comprising a sequence of convolution blocks. The machine-learning architecture comprises a depth branch configured to process the depth data, the depth branch comprising a sequence of convolution blocks. The machine-learning architecture comprises a combined branch configured to process combined color image and depth data, the combined branch comprising a sequence of convolution blocks. The machine-learning architecture of the machine-learning model comprises one or more fusing components configured to generate the combined color image and depth data based on an output of a convolution block of the color image branch and based on an output of a convolution block of the depth branch. The one or more fusing components are each (or alternatively one of the one or more fusing components is) configured to generate the combined color image and depth data using an attention mechanism that is based on the output of the convolution block of the color image branch and based on the output of the convolution block of the depth branch. The machine-learning architecture of the machine-learning model comprises an output component configured to provide an output of the machine-learning model, the output being based at least on an output of the combined branch.

FIG. 1c shows a flow chart of an embodiment of a corresponding method for processing color image data and depth data. The method comprises processing 190 the color image data and the depth image data using 195 the machine-learning model.

The following description relates both to the system of FIG. 1a and to the method of FIG. 1c. Features described in connection with the system of FIG. 1a may be likewise applied to the method of FIG. 1c.

In general, the output component of the machine-learning architecture of the machine-learning model is configured to provide the output of the machine-learning model, which is based at least on an output of the combined branch. In some embodiments, the output may be also fed by at least one of the other branches. In other words, the output component may be configured to provide the output further based on an output of the color image branch and/or based on an output of the depth branch. The output component may be configured to perform a combination operation based on the output of the combined branch and based on the output of at least one of the color image branch and the depth branch. For example, suitable combination operations and -operators have been introduced in connection with the machine-learning architecture of the first machine-learning model. For example, the combination operation may be an averaging operation.

As has been discussed in connection with the machine-learning architecture of the first machine-learning model, each or some of the branches may comprise additional layers or blocks, such as input layers/blocks (see e.g. FIG. 8 840, FIG. 9 940) and stem layers (see e.g. FIG. 8 850, FIG. 9 950). Additionally, at least one of the branches may comprise one or more detection head layers (FIG. 8 870, FIG. 9 970) and a prediction layer (FIG. 8 880, FIG. 9 980). For example, the color image branch, the depth branch and/or the combined branch may comprise one or more detection head layers and a prediction layer, as shown in FIGS. 8 and 9. For example, at least the combined branch may comprise one or more detection head layers and a prediction layer (since it is coupled to the output component). The prediction layer may be configured to provide an output of the respective branch based on an output of the one or more detection head layers. The one or more detection head layers may be configured to process an output of the one or more convolution blocks of the respective branch. These blocks/layers are configured to perform the actual functionality of the machine-learning model that is based on the machine-learning architecture, such as object detection.

The interface 102 may correspond to one or more inputs and/or outputs for receiving and/or transmitting information, which may be in digital (bit) values according to a specified code, within a module, between modules or between modules of different entities. For example, the interface 102 may comprise interface circuitry configured to receive and/or transmit information.

In embodiments the one or more processors 104 may be implemented using one or more processing units, one or more processing devices, any means for processing, such as a processor, a computer or a programmable hardware component being operable with accordingly adapted software. In other words, the described function of the one or more processors 104 may as well be implemented in software, which is then executed on one or more programmable hardware components. Such hardware components may comprise a general purpose processor, a Digital Signal Processor (DSP), a micro-controller, etc.

In at least some embodiments, the one or more storage devices 106 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

Embodiments of the present disclosure further provide a device (e.g. a surveillance camera) comprising the system 100, a camera sensor for providing the color image data, and a depth sensor for providing the depth image. For example, the system of the device may be configured to process the color image data and depth data, and/or to adapt the machine-learning architecture of the (first) machine-learning model.

More details and aspects of the system and methods are mentioned in connection with the proposed concept or one or more examples described above or below (e.g. 2a to 10). The system and methods may comprise one or more additional optional features corresponding to one or more aspects of the proposed concept or one or more examples described above or below.

Various embodiments of the present disclosure relate to an Automatic Fusion Architecture Design (AFAD-Net) for RGB-D object detection and related problems.

Sensor fusion for RGB and depth images will become more and more important in the near future. Embodiments may address the desire to find a fusion technique that improves a performance of a machine-learning model, e.g. for object detection. In other systems, an edge device without connection to some external control unit that performs inference of such a fusion network and whose network weights can be adapted to data via on-device training may be limited to the given architecture. Embodiments may provide an edge device that can not only retrain its weights, but its fusion architecture as well. Thus, a trainable device is proposed that captures additional data in a user's household and retrains the fusion architecture and weights for enhanced performance.

Embodiments of the present disclosure may provide an edge device with an RGB image sensor and a depth sensor (and a system 100 as introduced in connection with FIG. 1a). The primary task of this device may be to perform inference of an object detection network that fuses the RGB and D channels (using the system 100). The initial factory settings network and the initial fusion method may be given to the device, and in inference mode, it may simply perform the inference. Further, the device may have a display function—either with an own touchscreen display or by displaying on the user's smartphone/tablet. At a given moment in time (either triggered by time passed, like one week after unboxing or request of the user), the device may switch into an improvement mode. The improvement mode may work in such a way that the user is presented with some detection results, e.g. detection of humans in the room. An example of this is shown in FIGS. 2a to 2c. FIGS. 2a to 2d show illustrations of an object detection being evaluated. In FIGS. 2a and 2d, two living-room scenes are shown, with multiple (FIG. 2a) or a single (FIG. 2b) person in it. Bounding boxes 210 are superimposed over the living-room scenes, but they do not entirely fit the persons. For example, in FIG. 2a, three persons are shown, but one of the bounding boxes covers two persons. In FIG. 2b, the bounding box is shown around a lamp, and not around the person.

The user may now be asked to correct the detection result. The user can now correct the boxes in the touchscreen (shift, resize, add, delete, change caption if more than one class of object class). In FIGS. 2c and 2d, corrected bounding boxes 220 are drawn around the persons.

Those images and the corrected labels may be saved into the device's memory. It might have a collection of factory written images with labels (as set of training data) or it might not have those. However when additional data is added to the training data set, the detection/fusion network may be retrained in a specific way which can be simply one update of the weights (fine-tuning) per new image or a run over some epochs of the new images with the factory given dataset. The idea behind at least some embodiments is the training of the architecture (i.e. the adaptation of the machine-learning architecture of the (first) machine-learning model), which is described in the following.

Various embodiments of the present disclosure may perform automatic machine learning, where not only the weights of a given architecture are trained but also the architecture itself is trained. For comparison, the NAS (neural architecture search) method may be recalled (Zoph, Barret, et al. “Learning transferable architectures for scalable image recognition.” Proceedings of the IEEE conference on computer vision and pattern recognition. 2018.), whose objective is to design the best possible backbone architecture for a specific task and a specific dataset. Various embodiments propose AFAD (automatic fusion architecture design), where the backbone architecture is given, but automatically an improved (e.g. the best) possible fusion architecture is added to connect the RGB and D branches. The advantage of various implementations of AFAD is immediately clear: all levels of features can be considered for a fusion and all possible fusion operators. This cannot be tested manually in a practical amount of time.

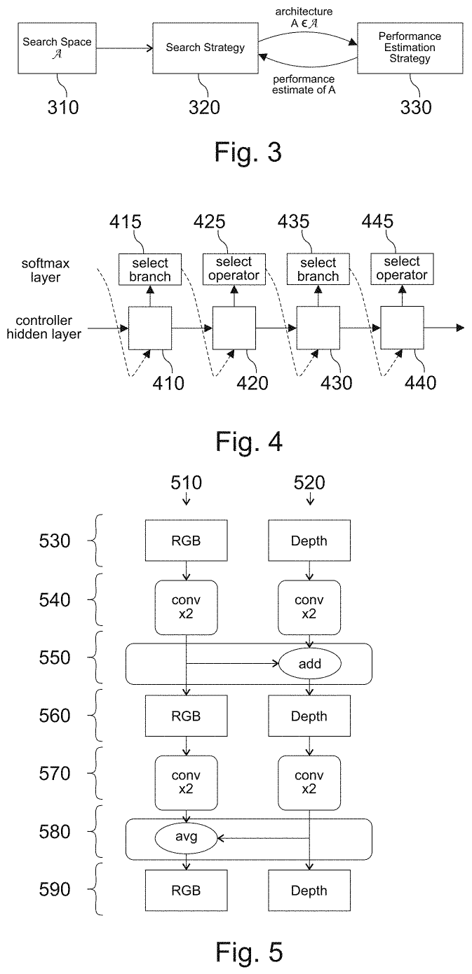

In the following, the approach of general automatic machine learning is introduced. Subsequently, the AFAD method is introduced. FIG. 3 shows a schematic diagram of an approach for adapting a machine-learning architecture. For example, there may be three components that may be fixed in advance. A first component is the search space 310, which defines the architectures that are possible to consider in the process, e.g. is there a maximum of layers (e.g. convolution blocks), which convolutional kernel sizes are allowed, which strides are allowed, etc.? The second component is the search strategy 320, which provides a method to find the best architecture from the search space. The third component is the performance estimation (strategy) 330, which compares specific architectures (a E A) with each other. Embodiments may provide the search space, while for the choice of a search strategy and performance estimation, the known literature may be used.

In the following, the functionality of AFAD is described. For a sample example, two branches of a detection network are considered, one for RGB and one for D data. Every feature (output of a layer) of one branch might be fused with every feature of the other branch. The search space may therefore comprise or consists of feature pairs of RGB and D locations, of possible fusion branches (RGB branch, D branch, mixed/combined branch) and of fusion operators (combination operators). For a specific objective and data set it may make sense to provide restrictions to speed up the training. Those restrictions could be a maximum number of fusion locations (i.e. the number or fusing components, e.g. 5), branch limitation (e.g. fuse to RGB branch only or no mixed branch or maximum two mixed branches), difference in resolution (e.g. maximum factor 4). Once the pairs of features have been chosen, the resolutions may be compared. The fusion may be performed into the branch with the smaller resolution. The feature with the larger resolution may be down-sampled, so the pair has the same resolution. The fuse may be performed either into the branch with the originally smaller resolution or into a mixed branch. The fusion operator may be selected next. Possible options are addition, concatenation, maximization, identity, averaging, multiplication and others. If after the prediction layer, there still are multiple branches, they may be fused through averaging.

In the following, the fusing/combination operators are elaborated. For example, elementwise addition may be used. For example, from the RGB branch (i.e. the color image branch), a feature map X of dimensions (N, C, H, W) may be obtained, where N is the batch size, C is the number of channels, and H×W (Height by Width) is the resolution of the feature map, for example dim(x)=(32, 256, 16, 16), with dim(x) being the dimensions of x. From the depth branch, a feature map Y of the same dimension may be obtained. The fusion may be calculated (for the addition) as z(i, j, k, l)=j, k, l)+j, k, l) in an elementwise manner and Z=(z(i, j, k, l)) has the same dimension like X and Y. Elementwise averaging may be performed similarly, with

$$z ( i , j , k , l ) = \frac{x ( i , j , k , l ) + y ( i , j , k , l )}{2} .$$

Elementwise multiplication is performed similarly, with z(i, j, k, l)=x(i, j, k, l)·y(i, j, k, l), as is elementwise maximum, with z(i, j, k, l)=max(x(i, j, k, l), k, y(i, j, k, l)). Concatenation in the channel dimension is another combination operation. If dim(X)=dim(Y)=(32,256,16,16), then dim(Z)=(32,512,16,16), i.e. the channels of one are concatenated with the channels of the other.

If the dimensions of the features are different (i.e. where the fusion is performed on different scales), the bigger resolution may be down-sampled with a convolution layer with stride. For example, if dim(X)=(32,256,16,16) and dim(Y)=(32,512,4,4), a 3×3 convolution layer is applied on X with stride (4,4), which downsamples the feature map by 4 in H and W and output channels=512. In formal terms, W=Conv(X), dim(W)=(32,512,4,4), Z=W+Y (elementwise).

In the following, some examples are shown. In the following example, the search space was limited to five fusion locations, no mixed branches and no differences in resolution i.e. only fuse on the same scale. The controller (e.g. the second machine-learning model introduced in connection with FIGS. 1a to 1c) may be an LSTM (Long Short-Term Memory) cell (comprising a controller hidden layer and a softmax layer), which may work in such a way that a branch to fuse is selected (by the softmax layer 415/435, based on the controller hidden layer 410/430), the operator is selected (by the softmax layer 425/445, based on the controller hidden layer 420/440) and it is repeated layer by layer, as shown in FIG. 4. FIG. 4 shows a schematic diagram of different hidden layers being used for adapting a machine-learning architecture.

In FIG. 5, an example for two layers is shown. FIG. 5 shows a schematic diagram of a machine-learning architecture of a machine-learning model for processing input data. FIG. 5 shows a RGB branch (i.e. color image branch) 510 and a depth branch 520, with RGB/Depth input layers 530, followed by two convolution layers (each) 540, a fusing layer (i.e. a fusing component) 550, where the RGB data is fused to the depth data using an addition operation, yielding RGB and depth data 560, followed by followed by two convolution layers (each) 570, a fusing layer (i.e. a fusing component) 580, where the depth data is fused to the RHB data using an averaging operation, yielding processed yielding RGB and depth data 560.

An AFAD-Net was trained with such limitations, and the architecture of FIG. 6 was obtained (a maximum of 5 fusion locations was set, but 4 were in the end result). FIG. 6 shows a schematic diagram of another machine-learning architecture of a machine-learning model for processing input data. FIG. 6 shows a depth branch 600 and an RGB branch 605. The two branches each comprise an input layer/block 610, a stem layer/block 620, and four convolution blocks 640. The RGB branch further comprises four “Extra” layers 640, which are detection head layers, and a prediction layer/block 650, which provides the output of the machine-learning model. Four fusing components 660-690 are included, one (addition) 660 after the first convolution block in the depth branch (from the outputs of the first convolution blocks of both branches, providing the input for the second convolution block of the depth branch), one (averaging) 670 after the second convolution block in the RGB branch (from the outputs of the second convolution blocks of both branches, providing the input for the third convolution block of the RGB branch), one (multiplication) 680 after the third convolution block in the depth branch (from the outputs of the second convolution blocks of both branches, providing the input for the fourth convolution block of the depth branch), and one (addition) 690 after the fourth convolution block in the RGB branch (from the outputs of the fourth convolution blocks of both branches, providing the input for the first of the Extra blocks. The prediction block takes its inputs from each of the extra blocks, from the third convolution block of the RGB branch and from the fusing component 690.

For a second example, the resolution difference was limited to maximum factor 8, fusion operators that were chosen was addition and concatenation (averaging in the end still allowed).

FIG. 7 shows a schematic diagram of different layers being used for adapting a machine-learning architecture. In this case, some location in RGB (RGB feature map) is selected 715 based on cell 710 (RGB_1 in the example shown in FIG. 7), some location in D (depth feature map) is selected 725 based on cell 720 (D 2 in the example), down-sampling if required is performed, a fusion operator is selected 735 based on cell 730 (addition in the example), and fusion is performed, etc. Such a network was trained, and the network of FIG. 8 was obtained. Interestingly some locations are used multiple times.

FIG. 8 shows a schematic diagram of a machine-learning architecture of a machine-learning model for processing input data, the machine-learning architecture comprising a combined/mixed branch. The machine-learning architecture of FIG. 8 comprises a depth branch 810, a mixed/combined branch 820 and an RGB branch 830. The depth branch and the RGB branch comprise input layers/blocks 840 and stem layers/blocks 850. All of the branches comprise convolution blocks 860 (three in the combined branch, four in the other branches), four “Extra” (detection head) blocks 870 and a prediction block 880. An averaging block (combination/fusing component) 890 is used to combine the outputs of the branches. The branches are fused at four locations, a) providing an input for the first convolution block of the combined branch (denoted Layer2), using an averaging operation based on the output of the stem layers of the other two branches, b) providing an input for the second convolution block of the combined branch (denoted Layer3), using a concatenation operation based on the output of the stem layer/block of the RGB branch, based on the output of the first convolution block of the combined branch and based on the output of the first convolution block of the depth branch, c) providing an input for the third convolution block of the combined branch (denoted Layer4), using a concatenation operation based on the output of the first convolution block of the RGB branch, based on the output of the second convolution block of the combined branch and based on the output of the second convolution block of the depth branch, and d) providing an input for the first extra block of the combined branch (denoted Extra1), using a concatenation operation based on the output of the second convolution block of the RGB branch, based on the output of the third convolution block of the combined branch and based on the output of the fourth convolution block of the depth branch.

The objective and approach explained above does not only occur in object detection. Embodiments of the present disclosure may also be applied to classification, secure authentication, image segmentation and related problems. Accordingly, the machine-learning model that is generated using such an approach (e.g. the first machine-learning model of FIGS. 1a to 1c) may be suitable for performing object detection, classification, secure authentication, and/or image segmentation based on color image data/RGB data and depth data. What is different is the scenario of acquisition of additional data. In case of classification the situation is clear. For example, the objective may be to classify a scene (party, dinner cooking, family sleeps) so the user can be presented with classification outputs and provide correction (label out of a choice). In case of authentication, the authorized user may be requested to be photographed from different angles or some examples of unauthorized users can be requested. In case of segmentation, segmentation output can be corrected by finger gestures on the touchscreen.

This may provide multiple benefits. On one hand, a device may be provided that can fine-tune to its new environment, providing better performance in changed illumination conditions. Embodiments might not simply retrain the weights of the network, but the fusion architecture may be re-trained as well. The results of this fusion method were evaluated, and a mAP score of 59.3 was obtained. Therefore, AFAD may perform better than the FuseNet approach introduced afore. In practice, results may be even better than this result suggests, since it is a trainable device that may be fine-tuned to the application data/environment.

More details and aspects of the concept are mentioned in connection with the proposed concept or one or more examples described above or below (e.g. FIG. 1a to 1c, 9 to 10). The concept may comprise one or more additional optional features corresponding to one or more aspects of the proposed concept or one or more examples described above or below.

Various embodiments of the present disclosure relate to a Cross-Attention Fusion (CAF-Net) mechanism for RGB-D object detection, image-Segmentation, classification and secure authentication. Embodiments may provide a new fusion method, which provides a novel cross-attention mechanism to combine RGB and D in such a way that trainable weight matrices place attention on the most significant network branch.

A fusion method is proposed that may significantly improve the performance of RGB-D object detection and that further can be applied to image segmentation, secure authentication, pose estimation, classification, and many other related objectives of computer vision with deep learning. The proposed fusion method may comprise one or more of the following three components: score level fusion, multi-path feature-level fusion and cross-attention fusion mechanism. While it is the combination of those three components that gives the best result, it is the cross-attention mechanism that has the biggest effect.

In FIG. 9, a machine-learning architecture of a proposed fusion network can be seen. FIG. 9 shows a schematic diagram of a machine-learning architecture of a machine-learning model for processing input data. The machine-learning architecture comprises an RGB branch 910, a combined/mixed branch 920 and a depth branch 930. The depth branch and the RGB branch comprise input layers/blocks 940 and stem layers/blocks 950. All of the branches comprise convolution blocks 960 (two in the combined branch, four in the other branches), four “Extra” (detection head) blocks 970 and a prediction block 970. An averaging block (combination/fusing component) 990 is used to combine the outputs of the branches. The machine-learning architecture comprises a fusing component (denoted Fuse) that uses an attention mechanism, providing the input for the first convolution block (denoted Layer3) of the combined branch, based on the outputs of the second convolution blocks of the other branches.

Score-level fusion: The boxes “Fuse” and “Avg” are the fusion layers. Consider the box “Avg”. Each branch of the network has its own output (prediction) Pred 980. Score-level fusion means that the scores or predictions are fused by averaging over the Prediction of the three branches (using the averaging block 990).

Multi-path feature-level fusion: In other concepts, such as the FuseNet approach, the depth branch is being fused into the RGB branch on feature-level (meaning inside the network) through addition in an early fusion stage. Consider the orange box “Fuse”. In multi-path feature-level fusion, the RGB and depth branches into a third mixed branch 920, but the RGB and D branches 910, 930 are kept separate for score-level fusion. Additional fusion may be performed later in the network into the same mixed branch or into an additional mixed branch.

The actual fusion is based on the cross-attention fusion mechanism, which is provided by the box “Fuse” in FIG. 9 based on the input of the RGB branch and D branch (denoted “depth”). In FIG. 9, a special case of the cross-attention mechanism is displayed (embedded Gaussian). In the following, the underlying operations are shown. FIG. 10 shows a schematic diagram of an (cross-) attention mechanism for a machine-learning architecture. In both the RGB 1050 and depth branches 1010, some H×W input is provided, which is reshaped to HW with C channels in the depth branch and C_{RGB} channels in the RGB branch. A non-local mean function can be defined as

$${y}_{i} = \frac{1}{C ( x )} {\sum }_{∀ j} f ( {x}_{i} , {x}_{j} ) g ( {x}_{j} )$$

where i is the index of an output position and j is the index of an input position. The function ƒ may be chosen as desired from the following: ƒ(xᵢ, xⱼ)=e^{x}^{ₗ}^{^{T}}^{x}^{ⱼ} (Gaussian), ƒ(xᵢ, xⱼ)=e^{θ}(xᵢ)^{T}ϕ(xⱼ) (Embedded Gaussian, see FIG. 10, with reference to the softmax function definition), ƒ(xᵢ, xⱼ)=ƒ(xᵢ)^{T}·ϕ(xⱼ) (Dot product), ƒ(xᵢ, xⱼ)=ReLU (w_{ƒ}^{T} [ƒ(xᵢ)^{T}, ϕ(xⱼ)]) (Concatenation). Here, the embeddings may be defined as θ(xᵢ)=W_{θ}xᵢ and ϕ(xⱼ)=W_{ϕ}xⱼ where the matrices W_{θ} and W_{ϕ} are trainable network weights. The normalization factor may be defined as C(x)=Σ_{∀i}ƒ(xᵢ, xⱼ) for Gaussian and Embedded Gaussian, and C(x)=N for dot product and concatenation. g(xⱼ) may be defined as g(xⱼ)=W_{g}xⱼ where W_{g} is a trainable matrix as well. The general cross-attention fusion mechanism may be defined as Z=(zᵢ)=Y+X_{RGB}=(yᵢ+x_{i,RGB}) where yᵢ is the output of some non-local mean function applied to X_{d}=(x_{i,d}) and X_{RGB}=(x_{i,RGB}) such that X_{d} is the input of ƒ and X_{RGB} is the input of g, and such that X_{d} and X_{RGB} are the reshaped versions of the input (reshaped to HW). In the special case of embedded Gaussian function, what is shown by FIG. 10 may be obtained, namely zᵢ=softmax(x_{i,d}^{T}W_{θ}^{T} W_{ϕ}x_{i,d})W_{g}x_{i,RGB}+x_{i,RGB} provided by block 1080, with softmax(x_{i,d}^{T}W_{θ}^{T}W_{ϕ}x_{i,d}) (dimensions HW×HW) being provided by block 1040, W_{g}x_{i,RGB}(dimensions HWxC_{RGB}) being provided by block 1060, softmax(x_{i,d}^{T}W_{θ}^{T}W_{ϕ}x_{i,d})W_{g}x_{i,RGB} (dimensions HWxC_{RGB}) being provided by block 1070 and x_{i,RGB} (dimensions HWxC_{RGB}) being provided by block 1050. Additionally, as shown in FIG. 10, a down-sampling 1020, 1030 of the channels by factor 8 (and later recombination) is performed, which helps but is not required.

All the three components of the fusion mechanism play a different role in improving fusion. Multi-branch fusion increases the information flow to the prediction. However, information increase is not always good for neural networks, but then score-level fusion works great to reduce the information even though it is simple. Evaluations showed that multi-branch fusion combined with score-level fusion provides a significant improvement over other approaches. It may be useful to highlight the importance of a specific branch depending on the data. In addition, the cross-attention mechanism may be helpful, as it trains weights that then place attention of the network to the most helpful branch. In combination, those methods may provide the largest improvements. In evaluation, feature-level RGB-D fusion yielded a mAP of 57.9, multi-branch and score-level fusion (without cross-attention) yielded a mAP of 59.5 and a Cross-attention fusion network (CAF-NET) yielded an mAP score of 60.3.

More details and aspects of the concept are mentioned in connection with the proposed concept or one or more examples described above or below (e.g. FIG. 1a to 8). The concept may comprise one or more additional optional features corresponding to one or more aspects of the proposed concept or one or more examples described above or below.

The following examples pertain to further embodiments:

(1) A computer-implemented system 100 for adapting a machine-learning architecture of a first machine-learning model, the system comprising one or more processors 104 and one or more storage devices 106, the machine-learning architecture comprising:

a color image branch 510; 605; 830; 910; 1050 configured to process color image data, the color image branch comprising a sequence of convolution blocks 540; 570; 630; 860; 960;
a depth branch 520; 600; 810; 930; 1050 configured to process depth data, the depth branch comprising a sequence of convolution blocks 540; 570; 630; 860; 960;

one or more fusing components 530; 580, 660; 670; 680; 690; 1080 configured to combine intermediary data of two or more of the branches, each fusing component being configured to combine an output of a first block of one of the branches and an output of a second block of another branch, an output of the fusing component being used as input of a third block of one of the branches, the third block being a convolution block of one of the sequences of convolution blocks; and an output component, configured to provide an output of the machine-learning model, the output being based on an output of one or more of the branches, wherein the system is configured to adapt 110 the machine-learning architecture of the first machine-learning model using a second machine-learning model, wherein the second machine-learning model is trained to select 120, for each of the one or more fusing components, the first block, the second block, and the third block.

(2) The system according to (1), wherein the second machine-learning model is further trained to select 130, for each of the one or more fusing components, a combination operator being used by the fusing component.

(3) The system according to one of (1) or (2), wherein the second machine-learning model is further trained to select 140 a number of fusing components to use in the machine-learning architecture.

(4) The system according to one of (1) to (3), wherein the machine-learning architecture comprises a combined branch 820; 920 configured to process combined color image and depth data, the combined branch comprising a sequence of convolution blocks 860; 960, an input to the combined branch being provided by one of the fusing components.

(5) The system according to (4), wherein the one fusing component is configured to generate the combined color image and depth data based on an output of a convolution block of the color image branch and based on an output of a convolution block of the depth branch, wherein the one fusing component is configured to generate the combined color image and depth data using an attention mechanism that is based on the output of the convolution block of the color image branch and based on the output of the convolution block of the depth branch.

(6) The system according to one of (4) or (5), wherein the one or more fusing components comprise a subset of fusing components being configured to combine an output of a first block of one of the branches, an output of a second block of another branch, and an output of a fourth block of a further branch, an output of the fusing component being used as input of a third block of one of the branches, wherein the machine-learning model is further trained to select 150, for each fusing component of the subset, the fourth block.

(7) The system according to one of (1) to (6), wherein the second machine-learning model is further trained to select 160 a number of convolution blocks of the sequences of convolution blocks.

(8) The system according to one of (1) to (7), wherein the system is configured to iteratively adapt 170 the machine-learning architecture by determining 172 a performance estimate of the first machine-learning model being based on the machine-learning architecture, providing 174 the performance estimate as input to the second machine-learning model, using 176 an output of the second machine-learning model to adapt the machine-learning architecture, determining 178 a performance estimate of the machine-learning model being based on the adapted machine-learning architecture, and repeating the process until a termination condition is met.

(9) The system according to (8), wherein the performance estimate of the machine-learning model is determined using a set of training data, the set of training data comprising color image data, depth data, and desired output data, wherein the system is configured to trigger 180 the adaption of the machine-learning architecture if the set of training data is changed, and wherein the system is configured to generate 185 the first machine-learning model based on the adapted machine-learning architecture after the adaption of the machine-learning architecture, and to train the first machine-learning model based on the set of training data.

(10) The system according to (9), wherein the system is configured to process 190 input data comprising color image data and depth data using 195 the first machine-learning model.

(11) A computer-implemented system 100 for processing color image data and depth data, the system comprising one or more processors 104 and one or more storage devices 106, wherein the system is configured to process 190 the color image data and the depth image data using a machine-learning model having a machine-learning architecture, the machine-learning architecture comprising:

a color image branch 830; 910 configured to process the color image data, the color image branch comprising a sequence of convolution blocks 860; 960;

a depth branch 810; 930 configured to process the depth data, the depth branch comprising a sequence of convolution blocks 860; 960;

a combined branch 820; 920 configured to process combined color image and depth data, the combined branch comprising a sequence of convolution blocks 860; 960;

one or more fusing components configured to generate the combined color image and depth data based on an output of a convolution block of the color image branch and based on an output of a convolution block of the depth branch, wherein the one or more fusing components are each configured to generate the combined color image and depth data using an attention mechanism that is based on the output of the convolution block of the color image branch and based on the output of the convolution block of the depth branch;

an output component 890; 990, configured to provide an output of the machine-learning model, the output being based at least on an output of the combined branch.

(12) The system according to (11), wherein the output component is configured to provide the output further based on an output of the color image branch and/or based on an output of the depth branch.

(13) The system according to (12), wherein the output component is configured to perform a combination operation based on the output of the combined branch and based on the output of at least one of the color image branch and the depth branch.

(14) The system according to (13), wherein the combination operation is an averaging operation.

(15) The system according to one of (11) to (14), wherein at least the combined branch comprises one or more detection head layers 870; 970 and a prediction layer 880; 980, the prediction layer being configured to provide an output of the respective branch based on an output of the one or more detection head layers, the one or more detection head layers being configured to process an output of the one or more convolution blocks of the respective branch.

(16) A computer-implemented method for adapting a machine-learning architecture of a first machine-learning model, the machine-learning architecture comprising:

a color image branch configured to process color image data, the color image branch comprising a sequence of convolution blocks, a depth branch configured to process depth data, the depth branch comprising a sequence of convolution blocks, one or more fusing components, configured to combine intermediary data of two or more of the branches, each fusing component being configured to combine an output of a first block of one of the branches and an output of a second block of another branch, an output of the fusing component being used as input of a third block of one of the branches, the third block being a convolution block of one of the sequences of convolution blocks, and an output component, configured to provide an output of the machine-learning model, the output being based on an output of one or more of the branches, wherein the method comprises adapting 110 the machine-learning architecture of the first machine-learning model using a second machine-learning model, wherein the second machine-learning model is trained to select, for each of the one or more fusing components, the first block, the second block, and the third block.

(17) A computer-implemented method for processing color image data and depth data, the method comprising processing 190 the color image data and the depth image data using 195 a machine-learning model having a machine-learning architecture, the machine-learning architecture comprising:

a color image branch configured to process the color image data, the color image branch comprising a sequence of convolution blocks;

a depth branch configured to process the depth data, the depth branch comprising a sequence of convolution blocks;

a combined branch configured to process combined color image and depth data, the combined branch comprising a sequence of convolution blocks;

one or more fusing components configured to generate the combined color image and depth data based on an output of a convolution block of the color image branch and based on an output of a convolution block of the depth branch, wherein the one or more fusing components are each configured to generate the combined color image and depth data using an attention mechanism that is based on the output of the convolution block of the color image branch and based on the output of the convolution block of the depth branch; and an output component, configured to provide an output of the machine-learning model, the output being based at least on an output of the combined branch.

(18) A computer program having a program code for performing the method of one of (16) or (17), when the computer program is executed on a computer, a processor, or a programmable hardware component.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. A computer-implemented system for adapting a machine-learning architecture of a first machine-learning model, the system comprising one or more processors and one or more storage devices, the machine-learning architecture comprising:
a color image branch configured to process color image data, the color image branch comprising a sequence of convolution blocks;
a depth branch configured to process depth data, the depth branch comprising a sequence of convolution blocks;
one or more fusing components configured to combine intermediary data of two or more of the branches, each fusing component being configured to combine an output of a first block of one of the branches and an output of a second block of another branch, an output of the fusing component being used as input of a third block of one of the branches, the third block being a convolution block of one of the sequences of convolution blocks; and
an output component, configured to provide an output of the machine-learning model, the output being based on an output of one or more of the branches,
wherein the system is configured to adapt the machine-learning architecture of the first machine-learning model using a second machine-learning model, wherein the second machine-learning model is trained to select, for each of the one or more fusing components, the first block, the second block, and the third block.

2. The system according to claim 1, wherein the second machine-learning model is further trained to select, for each of the one or more fusing components, a combination operator being used by the fusing component.

3. The system according to claim 1, wherein the second machine-learning model is further trained to select a number of fusing components to use in the machine-learning architecture.

4. The system according to claim 1, wherein the machine-learning architecture comprises a combined branch configured to process combined color image and depth data, the combined branch comprising a sequence of convolution blocks, an input to the combined branch being provided by one of the fusing components.

5. The system according to claim 4, wherein the one fusing component is configured to generate the combined color image and depth data based on an output of a convolution block of the color image branch and based on an output of a convolution block of the depth branch, wherein the one fusing component is configured to generate the combined color image and depth data using an attention mechanism that is based on the output of the convolution block of the color image branch and based on the output of the convolution block of the depth branch.

6. The system according to claim 4, wherein the one or more fusing components comprise a subset of fusing components being configured to combine an output of a first block of one of the branches, an output of a second block of another branch, and an output of a fourth block of a further branch, an output of the fusing component being used as input of a third block of one of the branches, wherein the machine-learning model is further trained to select, for each fusing component of the subset, the fourth block.

7. The system according to claim 1, wherein the second machine-learning model is further trained to select a number of convolution blocks of the sequences of convolution blocks.

8. The system according to claim 1, wherein the system is configured to iteratively adapt the machine-learning architecture by determining a performance estimate of the first machine-learning model being based on the machine-learning architecture, providing the performance estimate as input to the second machine-learning model, using an output of the second machine-learning model to adapt the machine-learning architecture, determining a performance estimate of the machine-learning model being based on the adapted machine-learning architecture, and repeating the process until a termination condition is met.

9. The system according to claim 8, wherein the performance estimate of the machine-learning model is determined using a set of training data, the set of training data comprising color image data, depth data, and desired output data, wherein the system is configured to trigger the adaption of the machine-learning architecture if the set of training data is changed, and wherein the system is configured to generate the first machine-learning model based on the adapted machine-learning architecture after the adaption of the machine-learning architecture, and to train the first machine-learning model based on the set of training data.

10. The system according to claim 9, wherein the system is configured to process input data comprising color image data and depth data using the first machine-learning model.

11. A computer-implemented system for processing color image data and depth data, the system comprising one or more processors and one or more storage devices, wherein the system is configured to process the color image data and the depth image data using a machine-learning model having a machine-learning architecture, the machine-learning architecture comprising:
a color image branch configured to process the color image data, the color image branch comprising a sequence of convolution blocks;
a depth branch configured to process the depth data, the depth branch comprising a sequence of convolution blocks;
a combined branch configured to process combined color image and depth data, the combined branch comprising a sequence of convolution blocks;
one or more fusing components configured to generate the combined color image and depth data based on an output of a convolution block of the color image branch and based on an output of a convolution block of the depth branch, wherein the one or more fusing components are each configured to generate the combined color image and depth data using an attention mechanism that is based on the output of the convolution block of the color image branch and based on the output of the convolution block of the depth branch; and
an output component, configured to provide an output of the machine-learning model, the output being based at least on an output of the combined branch.

12. The system according to claim 11, wherein the output component is configured to provide the output further based on an output of the color image branch and/or based on an output of the depth branch.

13. The system according to claim 12, wherein the output component is configured to perform a combination operation based on the output of the combined branch and based on the output of at least one of the color image branch and the depth branch.

14. The system according to claim 13, wherein the combination operation is an averaging operation.

15. The system according to claim 11, wherein at least the combined branch comprises one or more detection head layers and a prediction layer, the prediction layer being configured to provide an output of the respective branch based on an output of the one or more detection head layers, the one or more detection head layers being configured to process an output of the one or more convolution blocks of the respective branch.

16. A computer-implemented method for adapting a machine-learning architecture of a first machine-learning model, the machine-learning architecture comprising:
a color image branch configured to process color image data, the color image branch comprising a sequence of convolution blocks,
a depth branch configured to process depth data, the depth branch comprising a sequence of convolution blocks,
one or more fusing components, configured to combine intermediary data of two or more of the branches, each fusing component being configured to combine an output of a first block of one of the branches and an output of a second block of another branch, an output of the fusing component being used as input of a third block of one of the branches, the third block being a convolution block of one of the sequences of convolution blocks, and
an output component, configured to provide an output of the machine-learning model, the output being based on an output of one or more of the branches,
wherein the method comprises adapting the machine-learning architecture of the first machine-learning model using a second machine-learning model, wherein the second machine-learning model is trained to select, for each of the one or more fusing components, the first block, the second block, and the third block.

17. A computer-implemented method for processing color image data and depth data, the method comprising processing the color image data and the depth image data using a machine-learning model having a machine-learning architecture, the machine-learning architecture comprising:
a color image branch configured to process the color image data, the color image branch comprising a sequence of convolution blocks;
a depth branch configured to process the depth data, the depth branch comprising a sequence of convolution blocks;
a combined branch configured to process combined color image and depth data, the combined branch comprising a sequence of convolution blocks;
one or more fusing components configured to generate the combined color image and depth data based on an output of a convolution block of the color image branch and based on an output of a convolution block of the depth branch, wherein the one or more fusing components are each configured to generate the combined color image and depth data using an attention mechanism that is based on the output of the convolution block of the color image branch and based on the output of the convolution block of the depth branch; and
an output component, configured to provide an output of the machine-learning model, the output being based at least on an output of the combined branch.

18. A computer program having a program code for performing the method of claim 16, when the computer program is executed on a computer, a processor, or a programmable hardware component.

19. A computer program having a program code for performing the method of claim 17, when the computer program is executed on a computer, a processor, or a programmable hardware component.
